(19) United States
(12) Patent Application Publication
(10) Pub. No.: US 2019/0246634 A1
(43) Pub. Date: Aug. 15, 2019

(54) ANTIMICROBIAL CELLULOSIC FIBER, PRODUCTION METHOD AND APPLICATION THEREOF

(71) Applicant: Lushan Huamei Covered Yarn Co.,Ltd, Yaan (CN)

(72) Inventors: LEI LI, Yaan (CN); GUANTING LI, Yaan (CN)

(73) Assignee: Lushan Huamei Covered Yarn Co.,Ltd, Yaan (CN)

(21) Appl. No.: 15/969,791

(22) Filed: May 3, 2018

(30) Foreign Application Priority Data
Feb. 11, 2018 (CN) 2018101411574

(51) Int. Cl. A01N 25/10; A01N 43/66; A01N 43/54; A01N 43/20

(52) U.S. Cl. CPC A01N 25/10; A01N 43/20; A01N 43/54; A01N 43/66

(57) ABSTRACT

The present invention provides a production method of an antimicrobial cellulosic fiber which includes the following steps: A, preparing a reactive antibacterial compound: B, preparing an antimicrobial cellulosic fiber: B1, chemical immobilization: B2, processing the structural body by a metal promoter or a heat treatment to stabilize it, and obtain an antimicrobial cellulosic fiber. In the present invention, a reactive antibacterial compound is prepared by a reaction of a reactive compound and an antibacterial agent, the reactive antibacterial compound is chemically immobilized to the cellulosic fiber through the chemical bonds between the reactive compound and the cellulosic fiber, so that the structure of the cellulosic fiber is more stable.

### CROSS REFERENCE TO RELATED APPLICATIONS

This application is based upon and claims priority to Chinese Patent Application No. 2018101411574, filed on Feb. 11, 2018, the entire contents of which are incorporated herein by reference.

### TECHNICAL FIELD

The present invention relates to the field of textile technology, particularly to an antimicrobial cellulosic fiber, production method and application thereof.

### BACKGROUND

Cellulose is an essential component of the plant cell wall. Cellulose is a biomaterial that abounds on the earth and is naturally degradable in nature. With increasing attention to environmental protection, cellulose has caught people's attention.

Cellulosic materials can be obtained from the fibers of plants existing in the nature. Cellulosic fibers include cotton, pulp, etc. Cellulosic fibers are used for many purposes. For example, staple fibers used to make cotton-linen can be spun without further processing. Rayon and Lyocell fibers are obtained by dissolving cellulose in a solvent and preparing yarn by wet spinning. Cellulose derivatives, such as cellulose acetate, are dissolved in an organic solvent such as methylene chloride, acetone, etc., and then yarns are prepared by dry spinning while evaporating the solvent.

Cellulosic fibers were used long time ago for their good wearability. Recently, the demand for environmental friendly materials has increased the use of cellulosic fibers. Cellulosic fibers excel in sweat absorption because its hygroscopic performance is much better than other fibers, therefore cellulosic fibers are suitable for producing clothing that is in direct contact with the skin such as outdoor clothing, sportswear, shirts, jerseys, etc.

The antibacterial and deodorizing processes are not intended to sterilize and cure bacteria, but to inhibit and proliferate bacteria and fungus on the fibers. Antibacterial and deodorizing processes are safe for humans, although to a certain extent, these processes merely continuously keep antibacterial effect rather than high antibacterial activity.

General organic antibacterial materials are easier to process than inorganic antibacterial materials, and there is no obvious impact for the mechanical properties, transparency, and color of the fibers. As a result of these advantages, organic antibacterial materials are widely used in fibers. Halamine, hydantoin, imidazolinone, sulfadiazine and their derivatives are famous as organic antibacterial materials used in cellulosic fibers. These organic antibacterial materials lack lasting antibacterial effects, especially lack thermal stability, which limits their applications. Some organic antibacterial materials may cause skin irritation and tearing.

Compared with organic antibacterial materials, inorganic antibacterial materials have good thermal stability and no volatilization and decomposition. As a result of these advantages, inorganic antibacterial materials are widely used. Many metals, such as silver, copper, and zinc have strong antibacterial properties, and are safe and harmless to humans. However, these metals would detach from the cellulosic fibers, for example, their antimicrobial properties do not last long when washed.

Methods for providing fibers with antibacterial properties are now well known. Most of these methods rely on the methods of processing yarns or fabrics used in the past. However, the processing methods used in the past are far from satisfactory in the aspect of durability, firmness, etc., and thus, these processing methods used in the past cannot be flexibly applied to clothing factories.

More specifically, the processing methods used in the past are restrictive in obtaining antibacterial properties. For example, when an adhesive is added to firmly attach the antibacterial particles to the cloth, merely a limited amount of adhesive is allowed, thus limiting the number of antibacterial particles. Merely a few times of washing would make the antibacterial particles detached from the clothes, so that the clothes lose their antibacterial function. Many suggestions were proposed to solve this problem.

The inventor of the present invention has developed a double-layer sheath-core staple fiber which includes a cellulose core layer and a metal sheath. This type of staple fiber is obtained by coating metal component on the surface of cellulosic fiber. The metal sheath having high electroconductivity ensures that the staple fibers have the capability to block electromagnetic waves and suppress static electricity. The antibacterial activity of the metal components makes the staple fibers more hygienic.

However, the production of sheath-core staple fibers involves complex processes, including the etching of cellulosic fibers, the soaking of reducing agent solution, the soaking of the catalytic metal salt solution so that the surface is uniformly deposited with fine particles of the catalytic metal, pre-settling, and chemical plating. The metal constituting the sheath layer is bound to the cellulosic fiber of the core layer by the affinity of the anionic polymer. Therefore, in response to the changes of the ambience, the binding force between the metal coating and the cellulose gradually deteriorates, resulting in a separation between the two layers.

The antibacterial materials (such as silver) are mainly coated on the surface of the fiber to provide antibacterial properties to the fiber. However, the binding force between the antibacterial material and the fibers is insufficient, so it is difficult to prevent the antibacterial particles from detaching from the clothes, thus the antibacterial function would deteriorate, gradually.

### SUMMARY

In order to solve the problems existing in the prior art, the present invention aims to provide cellulosic fibers with antibacterial function, and tightly attach the antibacterial materials to the cellulosic fibers, so that the degree of the antibacterial function stops deteriorating.

A production method of an antimicrobial cellulosic fiber includes the following steps:

A, Preparing a Reactive Antibacterial Compound:
A1, preparing an aqueous dispersoid, wherein in the aqueous dispersoid, a concentration of the reactive compound is 10-300 g/l;
A2, adding an antibacterial agent to the aqueous dispersoid so that the reactive compound and the antibacterial agent react at a temperature of 10-90° C. for 0.5-6 hours to obtain a reactive antibacterial compound solution;
A3, drying the reactive antibacterial compound solution and then crushing to obtain a purified reactive antibacterial compound;

B, preparing the antimicrobial cellulosic fiber:
B1, chemical immobilization: immersing a cellulosic fiber or fabric in an aqueous solution including 10-100 g/l reactive antibacterial compound, 5-50 g/l sodium carbonate, 20-200 g/l sodium sulfate with a bath ratio of 1:5-50 and reacting at a temperature of 40-90° C. for 10-100 mins to form a chemical bond; or performing chemical immobilization by a padding-drying process: padding the cellulosic fiber or fabric in a solution including 10-100 g/l reactive antibacterial compound, 10-100 g/L sodium carbonate, and 10-100 g/L sodium sulfate, then processing a padded cellulosic fiber or fabric at a temperature of 100-180° C. by a steam or dry heat treatment; making a weight of the reactive antibacterial compound to be 0.1-10.0% of a weight of the cellulosic fiber through the chemical immobilization; and obtaining a cellulosic fiber structural body;
B2, processing the cellulosic fiber structural body by a metal promoter or a heat treatment to stabilize the cellulosic fiber structural body and obtain the antimicrobial cellulosic fiber.

Further, in step B2, the step of performing stabilization by using the metal promoter includes: heating the cellulosic fiber structural body and 0.5-5% metal promoter at a temperature of 10-90° C. until the weight of the metal promoter reaches 0.05-5.00% of the weight of the cellulosic fiber. The step of the heat treatment includes, immersing the cellulosic fiber structural body in an aqueous solution of at least one item selected from organometallic compound, organosilicon compound, organofluorine compound, organophosphorus compound, and organonitrogen compound, then performing the steam or dry heat treatment at a temperature of 100-200° C. for 10 s-10 mins.

Further, the reactive compound is one or more item selected from triazine compound, pyrimidine compound, quinoxaline compound, divinyl sulfone compound, epoxy compound, carbamate compound, and acrylamide compound.

Further, the triazine compound is cyanuric chloride, the pyrimidine compound is tetrachloropyrimidine, the quinoxaline compound is chlorocarbonyl dichloroquinoxaline, the divinyl sulfone compound is sulfoethanesulfonic acid, the epoxy compound is epichlorohydrin, the carbamate compound is glyoxal carbamate, and the acrylamide compound is bromoacetamide.

Further, the antibacterial agent may be one or more item selected from natural antibacterial agent, synthetic antibacterial agent, antifungal agent, and antiviral agent. The natural antibacterial agent is one or more item selected from macrolides, aminoglycosides, cephalosporins, penicillins, chitosans, chitins, hyaluronic acids, alginates, carrageenan, xanthan gum, gellan, amino acids, and proteins. The synthetic antibacterial agent is one or more item selected from carbostyril, sulfonamides, diamidines, bisphenols, guanidines, biguanides, imidazoliums, quanethidines, sulfanilic acid, salicylic acid, aminobenzoic acid, hydantoin, and imidazolinone.

Further, in the step A2, an alkali may be added as a catalyst to accelerate the reaction. The alkali is caustic soda, sodium carbonate, sodium percarbonate, or sodium acetate.

In addition, an antimicrobial cellulosic fiber or fabric produced by the above production method is also provided.

Further, the cellulosic fiber may be a plant fiber, a regenerated fiber, a natural protein fiber, or a regenerated protein fiber.

Further, the anti-bacterial-cellulose fiber has a bacteriostasis rate ranged from 99% to 99.99%, and a deodorization rate of an alkaline odor ranged from 90% to 100%.

In addition, the applications of the antimicrobial cellulosic fibers produced by the above production method in the preparation of fabrics are also provided.

Compared with the prior art, the advantages of the present invention are as follows.

1. In the present invention, a reactive antibacterial compound is prepared by a reaction between a reactive compound and an antibacterial agent. The reactive antibacterial compound and the cellulosic fiber are chemically immobilized through a chemical bond between the reactive compound and the cellulosic fiber, so that the cellulosic fiber structure is stabilized.

2. The antibacterial cellulosic fiber of the present invention is a human-friendly material having excellent antibacterial activity and deodorizing performance. The anti-microbial-cellulose fibers according to the embodiments of the present invention may be made of raw cotton, sliver, roving, spun yarn, woven fabric, knitted fabric, non-woven fabric, etc. The antimicrobial cellulosic fiber according to the present invention may be mixed with other fibers such as natural fibers and synthetic fibers. In this case, the antimicrobial cellulosic fiber according to the embodiment of the present invention may be used for producing products for various uses depending on the kinds of the mixed fibers and the mixing method and ratio.

3. In addition, the antibacterial agent is stably bound to the cellulosic fiber by the chemical bonding between the reactive compound and the cellulosic fiber. Such chemical bonding prevents the antibacterial agent from escaping from the fiber easily, for example, during the washing process, so that the antibacterial cellulosic fiber can maintain its antibacterial function for a long time.

4. In the cellulosic fiber structure, the reactive antibacterial compound is chemically fixed to the cellulosic fiber, and the antibacterial agent is stably bound to the cellulosic fiber by the reactive compound. As a result of the chemical bonds and the stable bonding function, the antibacterial compounds can be prevented from easily detaching from the fibers during the washing process, so that the anti-bacterial-cellulose fibers can maintain their antibacterial function for a long time.

### BRIEF DESCRIPTION OF DRAWINGS

In order to more clearly explain the embodiments of the present invention or the technical solutions in the prior art, the drawings necessary for the description of the embodiments or the prior art will be briefly described below. Obviously, the drawings described below are the embodiments of the present invention, and other drawings may also be derived from these drawings without creative effort by those skilled in the art.

FIG. 1 is an image showing bacterial growth in a cotton fabric produced by the antibacterial cotton fiber produced according to embodiment 4.

FIG. 2 is an image showing the test results of the antibacterial activity of the cotton fabric produced according to embodiment 5 against Staphylococcus aureus and Klebsiella pneumoniae which are used as tested bacterial strains.

### DETAILED DESCRIPTION

In the present invention, unless specific explanation, the scientific and technical terms used herein refer to the terms that have common meanings to those skilled in the art.

The production method of an antimicrobial cellulosic fiber of the present invention includes making a reactive compound react with an antibacterial agent to prepare a reactive antibacterial compound, chemically immobilizing the reactive antibacterial compound to the cellulosic fiber by chemical bonding between the reactive compound and the cellulosic fiber, and stabilizing the structure of cellulosic fiber.

First, a production method of an antimicrobial cellulosic fiber is provided by the present invention which includes the following steps.

A, preparation of reactive antibacterial compounds:
A1, preparation of an aqueous dispersoid: a reactive compound is dispersed in an aqueous solution at a temperature of 1-40° C. and reacts for 10-30 mins to obtain an aqueous dispersoid, and the concentration of the reactive compound is 10-300 g/l;
A2, an antibacterial agent is added to the aqueous dispersoid for 5-10 mins, the reactive compound and the antibacterial agent react at a temperature of 10-90° C. for 0.5-6 h to obtain a reactive antibacterial compound solution, wherein the amount of the antibacterial agent added is 1-10 times of the mole number of the reactive compound;
A3, the reactive antibacterial compound solution is dried and crushed to obtain a purified reactive antibacterial compound;
wherein, in step A1, a nonionic surfactant or an acid may be added during the preparation of the aqueous dispersoid, if a nonionic surfactant is added, the concentration of the nonionic surfactant in the aqueous dispersoid is 1-10 g/l, the addition of acid or nonionic surfactant facilitates the reaction.

B, preparation of antimicrobial cellulosic fiber:
B1, chemical immobilization: the cellulosic fibers (for example, raw cotton, sliver, roving, or two-stranded yarn) or fabrics made of cellulosic fibers by weaving, knitting, or bonding weaving (for example, woven fabrics, knitted fabrics, or nonwoven fabrics) are immersed in an aqueous solution including 10-100 g/l reactive antibacterial compound, 5-50 g/l sodium carbonate, 20-200 g/l sodium sulfate with a bath ratio of 1:5-50, the reaction is performed for 10-100 mins at a temperature of 40-90° C. to form chemical bonds, or the chemical immobilization is carried out by a padding-drying process, wherein the cellulosic fiber or fabric are padded by a solution including 10-100 g/l reactive antibacterial compound, 10-100 g/L sodium carbonate, and 10-100 g/L sodium sulfate, then the padded cellulosic fiber or fabric is processed by steam or dry heat treatment at a temperature of 100-180° C. to make the weight of the reactive antibacterial compound 0.1-10.0% of the weight of the cellulosic fiber, so that a cellulosic fiber structural body is obtained;
preferably, based on the weight of the cellulosic fiber, the content of the reactive antibacterial compound is 0.1-10.0%, more preferably 0.5-5.0%, if the content of the reactive antibacterial compound is less than 0.1%, the antibacterial effect would be poor, if the content of the reactive antibacterial compound exceeds 10.0%, it is not economically effective, when chemical immobilization is performed by the padding-drying process, generally, 1 L of padding solution is required for 200 g fabrics;
B2, the cellulosic fiber structural body is processed by a metal promoter or a heat treatment to stabilize it and obtain an antimicrobial cellulosic fiber, since the structure of the cellulosic fiber is stabilized by metal promoter or heat treatment, the antibacterial performance, functionality, or fastness of the antimicrobial agent of the antibacterial cellulosic fiber is improved by such stabilizing effect.

The cellulosic fiber structural body may be immobilized by the following reaction: 0.5-5% of metal compound aqueous solution (as a metal promoter) reacts with the cellulosic fiber structural body at the temperature of 10-90° C. until the content of the metal compound reaches 0.05-5% of the weight of the cellulosic fiber. The metal compound is selected from sodium hydroxide, potassium hydroxide, calcium hydroxide, sodium carbonate, silver nitrate, zinc sulfate, zinc chloride, tin chloride, calcium chloride, copper sulfate and a mixture thereof. The metal compound decomposes into metal ions in the aqueous solution. The metal ions are adsorbed to the fiber by hydroxyl of the cellulosic fiber and react with the reactive antibacterial compounds to form complexes. The antibacterial activity of the cellulosic fiber is improved by the complexation. For example, during the washing process, the complexes would not escape from fibers easily due to their insolubility.

The cellulosic fiber structure is immersed in an aqueous solution of at least one functional agent selected from catalyst, softening agent, waterproof agent, flame retardant, and function enhancer, and then processed by steam or dry heat treatment for 10 seconds to 10 minutes at the temperature of 100-200° C. The bonding between the cellulosic fiber and the reactive antibacterial compound is enhanced by the heat treatment, so that the bonding of the antibacterial cellulosic fiber is improved. Preferably, the catalyst is an organic metal compound, the softening agent is an organosilicon compound, the flame retardant is an organofluorine or organophosphorus compound, and the function enhancer is an organonitrogen compound. The functional agent and the reactive antimicrobial agent work together to realize the functions of deodorization, flexibility, waterproofness, flame retardancy, hygroscopicity, fast-drying ability, the moisture absorption and heat releasing property, and the ultraviolet-radiation-preventing etc.

The reactive antibacterial compound is abbreviated as “ReAm”. The reactive compound is used for chemically bonding the reactive antibacterial compound with the cellulosic fiber, and is defined as a reactive group abbreviated as “Re”. The antibacterial agent shows an antibacterial function and is defined as a functional group abbreviated as “Am”. The reactive group Re reacts with the functional group Am to synthesize the reactive antibacterial compound ReAm, and the reactive antibacterial compound ReAm is stably bonded to the cellulosic fiber in the follow up steps.

The reactive group Re may be selected from one or a combination of a triazine compound, a pyrimidine compound, a quinoxaline compound, a divinyl sulfone compound, an epoxy compound, a carbamate compound, and an acrylamide compound. Specifically, an example of a triazine compound is cyanuric chloride, an example of a pyrimidine compound is tetrachloropyrimidine, an example of a quinoxaline compound is chlorocarbonyl dichloroquinoxaline, an example of a divinyl sulfone compound is sulfoethanesulfonic acid, an example of an epoxy compound is epichlorohydrin, an example of a carbamate compound is glyoxal carbamate, and an example of an acrylamide compound is bromoacetamide.

The functional group Am may be selected from natural antibacterial agents, synthetic antibacterial agents, antifungal agents, and antiviral agents. Specific examples of natural antibacterial agents include macrolides, aminoglycosides, cephalosporins, penicillins, chitosans, chitins, hyaluronic acids, alginates, carrageenan, xanthan gum, gellan, amino acids, and proteins. Specific examples of synthetic antibacterial agents include carbostyril, sulfonamides, diamidines, bisphenols, guanidines, biguanides, imidazolium, quanethidine, sulfanilic acid, salicylic acid, aminobenzoic acid, hydantoin, and imidazolinone. The antibacterial agent is not limited to a specific kind as long as the antibacterial agent has an antibacterial effect and is safe for the human body.

Examples of cellulosic fibers suitable for the embodiments of the present invention include: plant fibers such as cotton fiber, fibrilia, pulp, sisal, abaca, kapok, pueraria fiber, flax, jute, boehmeria nivea, hemp, kenaf, coconut shell; regenerated fibers such as viscose fiber, cuprammonium rayon, viscose rayon, Lyocell fiber, tencel, and cellulose acetate; natural protein fibers such as animal fibers (wool, silk, pashm, alpaca, offspring of the sheep and llama, guanaco, Misti alpaca, yamma, musk ox hair, Koshgora wool and camel hair); regenerated protein fiber (such as meat protein fibers, milk protein fibers and plant protein fibers).

In step A, the reaction conditions may be adjusted according to the type of reactive group Re.

### Embodiment 1, Preparation of Reactive Antibacterial Compounds

For example, in the condition where a triazine compound is used as the reactive group Re, the reactive antibacterial compound may be synthesized by the following method. An aqueous dispersoid is prepared by uniformly dispersing 10-300 g/l cyanuric chloride and 1-10 g/l nonionic surfactant in water and hydrolyzing at a temperature of 0-5° C. for 10-30 minutes, and sulfamethyl sulfonate or sulfanilate with 5-10 times molar amount of the cyanuric chloride is added into the aqueous dispersoid to play a role of functional group Am and react for 10-100 minutes, then the reactive group Re and the functional group Am are stirred at a temperature of 10-60° C. for 0.5-3 hours.

### Embodiment 2, Preparation of Reactive Antibacterial Compounds

In the condition where a pyrimidine compound is used as the reactive group Re, the reactive antibacterial compound may be synthesized by the following method. An aqueous solution is prepared by uniformly dispersing 10-300 g/l tetrachloropyrimidine and 1-10 g/l nonionic surfactant in water at a temperature of 20-40° C. for 10-30 minutes, sulfadimidine or sulfanilamide with 5-10 times molar amount of the tetrachloropyrimidine is added to the aqueous solution to play a role of functional group Am and react for 10 to 100 minutes, and the reactive group Re and the functional group Am are stirred at a temperature of 20-80° C. for 1-6 hours.

### Embodiment 3, Preparation of Reactive Antibacterial Compounds

In the condition where an epoxy compound is used as the reactive group Re, the reactive antibacterial compound may be synthesized by uniformly dispersing 10-200 g/l epichlorohydrin which is regarded as the epoxy compound in a mixture consisting of water and 50-90% ethanol for 10-30 minutes, so that an aqueous solution is prepared. Sulfanilate or sulfanilic acid is added to the aqueous solution to play a role of functional group Am, wherein the sulfanilate or sulfanilic acid has 5-10 times molar amount of the epichlorohydrin, and react for 10 to 100 minutes, and the reactive group Re and the functional group Am are stirred at a temperature of 30-90° C. for 1-4 hours.

The reactive antibacterial compound is synthesized by the substitution reaction and functional reaction of the triazine, pyrimidine, and quinoxaline compound and the addition reaction of the epoxy compound and functional group, and alkali may be added as a catalyst to accelerate the reaction. The alkali that can be used as catalyst includes caustic soda, sodium carbonate, sodium percarbonate, and sodium acetate. For the aqueous solution of the reactive group Re, the alkali is gradually added to react for 0.5 to 2 hours, and the molar weight of the alkali to the molar weight of the functional group Am is 0.5-10.

In addition, the reactive antibacterial compound may also be prepared by using the antibacterial agent Am and sulfo-ethanesulfonic acid as a reactive compound in the reaction, wherein the antibacterial agent Am is combined with divinyl sulfone, and then the reactive antibacterial compound is chemically immobilized to the hydroxyl of the cellulosic fiber by chemical bonding. The process is shown as the following chemical equation:

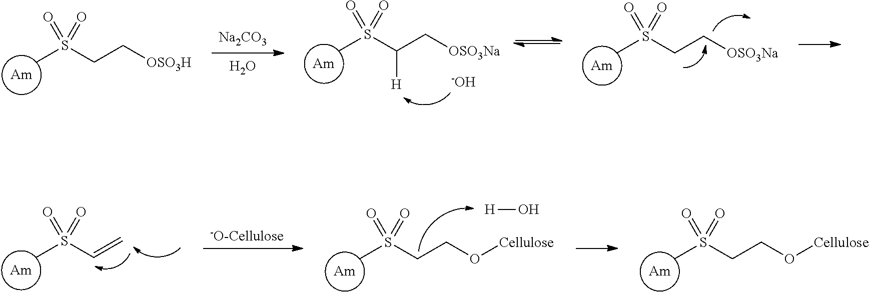

In addition, a reactive antibacterial compound may be prepared by reaction of an antibacterial agent Am having an amino group and cyanuric chloride, wherein the antibacterial agent Am is combined with the triazine compound (2-amino-4,6-dichloro-s-triazine), and then the reactive antimicrobial compound is chemically bonded and immobilized to the hydroxyl groups of the cellulosic fiber by chemical methods. The process is shown as the following equation:

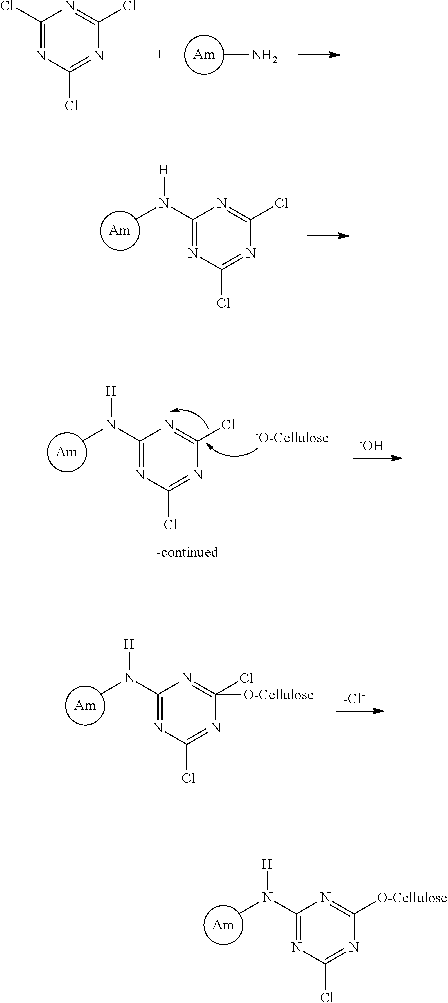

### Embodiment 4

4.1 Antimicrobial Cellulosic Fiber and Production Process Thereof

7.38 g cyanuric chloride and 0.6 g Triton X-100 which was used as a surfactant were added to 200 ml water and stirred by 10 minutes for dispersion while the temperature was kept at 5° C.

Five 50 ml aqueous solutions of 6.89 g sulfanilamide and 1.6 g caustic soda were added to the dispersoid for 30 minutes. The mixture was heated to 20° C. and stirred for 90 minutes to synthesize a reactive antibacterial compound.

Next, 37.5 g sodium chloride was added to the reactive antibacterial compound to form precipitate. The precipitate was filtered and washed to remove unreacted material, and then dried and crushed to obtain the powder of purified reactive antibacterial compound.

100% combed cotton fiber was immersed in an aqueous solution containing 50 g/l purified reactive antibacterial compound powder, 15 g/l sodium carbonate, and 50 g/l sodium sulfate at a temperature of 40° C. for 30 minutes. The cotton fiber was used at a bath ratio of 1:10 so that the weight of the pure reactive antibacterial compound powder is 3.5% of the weight of the fiber. The cotton fiber was washed with water and dried to obtain a cellulosic fiber with chemically immobilized reactive antimicrobial compound.

The cellulosic fiber structural body was immersed in an aqueous solution of organometallic compound, organosilicon compound, organofluorine compound, organophosphorus compound, and organic nitrogen compound, and each compound was 0.2%. The obtained cellulosic fiber structural body was treated by steam at a temperature of 150° C. for 3 minutes to prepare the anti-bacterial-cellulose fiber.

4.2 Menstruation of Antibacterial Activity and Deodorization Rate of Antimicrobial Cellulosic Fiber Prepared According to Embodiment 4

The antibacterial cellulosic fiber according to Embodiment 1 was woven into a cotton fabric.

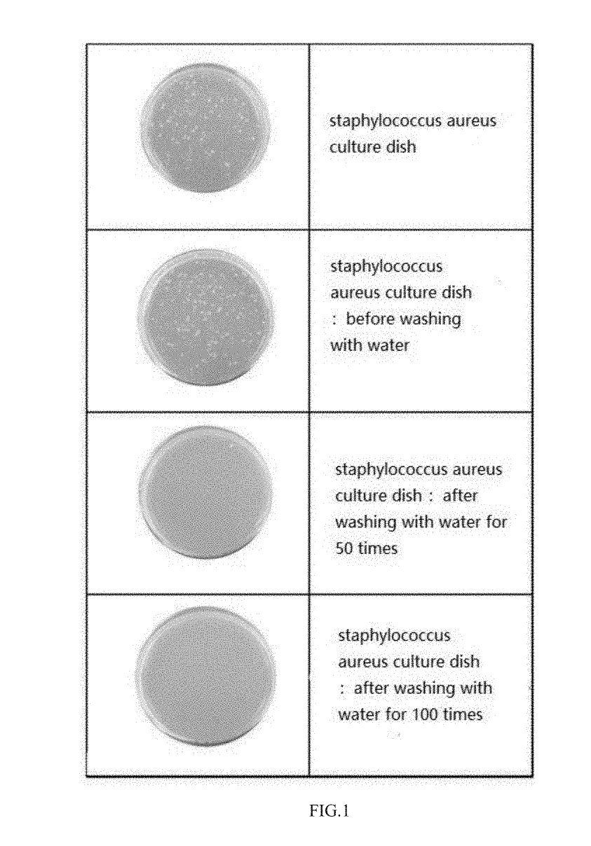

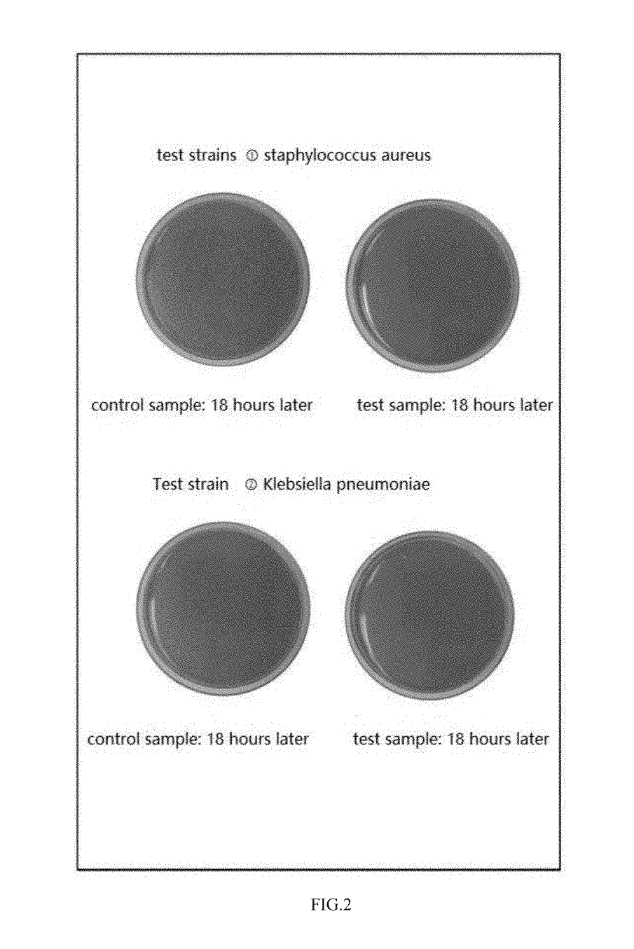

According to the test method of KS K 0693-2007, Staphylococcus aureus (ATCC 6538) was used as test strains to test the cotton fabrics. The test results are shown in FIGS. 1 and 2. As shown in FIG. 1, the cotton fabric sample before washing and after circularly washing for 50 times according to the method of KS K ISO 6330:2011 was tested, and the result shows that the bacteriostasis rate was 99.9% or more. The bacteriostasis rate of the cotton fabric sample being washed for 100 times was 98.6%.

As shown in FIG. 1, bacteria are represented by white dots. Bacteria: the blank shows the image of normal cotton fabric, and many multiplied bacteria can be seen from the image. In contrast, no or less bacteria were observed from the antibacterial cotton fabric sample made according to the embodiments of the present invention before washing, or after 50-time or 100-time washing.

The deodorization rate of ammonia gas was tested in a detection tube method. After 2 hours, the deodorization rate of the ammonia gas of the antibacterial cotton fabric made according to the embodiments of the present invention was measured as 95%.

### Embodiment 5

5.1 Anti-bacterial-cellulose Fiber and Production Process thereof 0.02 mol cyanuric chloride was mixed with a small amount of acid and uniformly dispersed in 200 ml distilled water under stirring while the temperature was kept at a temperature of 5° C. or below.

When the temperature was kept below 5° C., 0.02 mol sulfamethazine and a small amount of acid were successively added to distilled water, and were uniformly dispersed.

The sulfamethazine solution was slowly added to the cyanuric chloride solution and reacted for 2 hours. After the reaction was completed, the reaction solution was cooled, neutralized, dehydrated, and vacuum-dried to obtain a reactive antibacterial compound of sulfamethazine.

100 g water and 10 g glacial acetic acid were added to the reactive antibacterial compound to prepare a reaction solution. Ten worsted cotton woven fabrics each having a weight of 20 g were processed by the reaction solution at a temperature of 40° C. for 30 minutes to obtain the reactive antimicrobial compound with a content of 0.1%.

The processed cotton fibers were washed with water and dried to obtain a cotton fabric which is chemically immobilized with reactive antibacterial compound.

The cotton fabric structural body was immersed in a 1.0 wt % silver nitrate aqueous solution to form a sulfamerazine silver ion complex

5.2 Mensuration of Antibacterial Activity and Deodorization Rate of Antimicrobial Cellulosic Fiber Prepared According to Embodiment 5

The antibacterial cotton fabrics according to Embodiment 2 where the silver ion complex is formed were tested and analyzed.

According to the test method of KS K 0693-2011, Staphylococcus aureus (ATCC 6538) and Klebsiella pneumoniae (ATCC 4352) were used as test strains to test the antibacterial cotton fabrics. The concentrations of Staphylococcus aureus and Klebsiella pneumonia of the inoculum were 1.3×10⁵ CFU/ml and 1.5×10⁵ CFU/ml, respectively.

According to the method of KS K SO 6330:2006, the antimicrobial fabric samples were washed 50 times. The test results are shown in FIG. 2, bacteriostasis rates of Staphylococcus aureus and Klebsiella pneumoniae are reduced to greater than 99.9%.

As shown in FIG. 2, the bacteria were inoculated to a general cotton fabric as a control sample, and a photo was taken after 18 hours. It can be learned from the image that Staphylococcus aureus and Klebsiella pneumoniae were multiplied. The bacteria were inoculated to the antibacterial cotton fabric sample made according to Embodiment 4 as a test sample, and a photo was taken after 18 hours. It can be learned from the image that there is no Staphylococcus aureus and Klebsiella pneumoniae observed.

The above-mentioned embodiments are merely used to illustrate the technical solutions of the present invention rather than limit the present invention. Although the present invention has been described in detail with reference to the foregoing embodiments, modifications of the technical solutions described in the forgoing embodiments or equivalent substitutions of some of the technical features can be done by those skilled in the art, and these modifications or substitutions will not depart the nature of the corresponding technical solutions from the spirit and scope of the technical solutions claimed by the present invention.

1. A production method of an antimicrobial cellulosic fiber comprising:
preparing a reactive antibacterial compound, wherein the step of preparing the reactive antibacterial compound further comprises
preparing an aqueous dispersoid, wherein in the aqueous dispersoid, a concentration of the reactive compound is 10-300 g/l;
adding an antibacterial agent to the aqueous dispersoid so that the reactive compound and the antibacterial agent react at a temperature of 10° C.-90° C. for 0.5-6 hours to obtain a reactive antibacterial compound solution;
drying the reactive antibacterial compound solution and then crushing to obtain a purified reactive antibacterial compound;
preparing the antimicrobial cellulosic fiber, wherein the step of preparing the antimicrobial cellulosic fiber further comprises:
performing a chemical immobilization, wherein the chemical immobilization comprises:
immersing a cellulosic fiber or fabric in an aqueous solution comprising 10-100 g/l reactive antibacterial compound, 5-50 g/l sodium carbonate, 20-200 g/l sodium sulfate with a bath ratio of 1:5-50; and reacting at a temperature of 40° C.-90° C. for 10-100 mins to form a chemical bond; or
the chemical immobilization is implemented by performing a padding-drying process comprising: padding the cellulosic fiber or fabric in a solution comprising 10-100 g/l reactive antibacterial compound, 10-100 g/L sodium carbonate, and 10-100 g/L sodium sulfate, then processing a padded cellulosic fiber or fabric at a temperature of 100° C.-180° C. by a steam or dry heat treatment; making a weight of the reactive antibacterial compound to be 0.1-10.0% of a weight of the cellulosic fiber through the chemical immobilization, and obtaining a cellulosic fiber structural body;
and processing the cellulosic fiber structural body by a metal promoter or a heat treatment to stabilize the cellulosic fiber structural body and obtain the antimicrobial cellulosic fiber.

2. The production method of an antimicrobial cellulosic fiber according to claim 1, wherein
the step of performing stabilization by using the metal promoter comprises:
heating the cellulosic fiber structural body and 0.5-5% metal promoter at a temperature of 10° C.-90° C. until a weight of the metal promoter reaches 0.05-5.00% of the weight of the cellulosic fiber;
the step of the heat treatment comprises: immersing the cellulosic fiber structural body in an aqueous solution of at least one item selected from the group consisting of organometallic compound, organosilicon compound, organofluorine compound, organophosphorus compound, and organonitrogen compound; and
performing a steam or dry heat treatment at a temperature of 100° C.-200° C. for 10 seconds-10 minutes.

3. The production method of an antimicrobial cellulosic fiber according to claim 1, wherein
the reactive compound is one or more item selected from the group consisting of triazine compound, pyrimidine compound, quinoxaline compound, divinyl sulfone compound, epoxy compound, carbamate compound, and acrylamide compound.

4. The production method of an antimicrobial cellulosic fiber according to claim 3, wherein
the triazine compound is cyanuric chloride, the pyrimidine compound is tetrachloropyrimidine, the quinoxaline compound is chlorocarbonyl dichloroquinoxaline, the divinyl sulfone compound is sulfoethanesulfonic acid, the epoxy compound is epichlorohydrin, the carbamate compound is glyoxal carbamate, and the acrylamide compound is bromoacetamide.

5. The production method of an antimicrobial cellulosic fiber according to claim 1, wherein
the antibacterial agent is one or more item selected from the group consisting of natural antibacterial agent, synthetic antibacterial agent, antifungal agent, and antiviral agent;
wherein, the natural antibacterial agent is one or more item selected from the group consisting of macrolides, aminoglycosides, cephalosporins, penicillins, chitosans, chitins, hyaluronic acids, alginates, carrageenan, xanthan gum, gellan, amino acids, and proteins; and
the synthetic antibacterial agent is one or more item selected from the group consisting of carbostyril, sulfonamides, diamidines, bisphenols, guanidines, biguanides, imidazoliums, quanethidines, sulfanilic acid, salicylic acid, aminobenzoic acid, hydantoin, and imidazolinone.

6. The production method of an antimicrobial cellulosic fiber according to claim 1, wherein in the step of adding an antibacterial agent to the aqueous dispersoid, an alkali is further added as a catalyst to accelerate the reaction; and
the alkali is caustic soda, sodium carbonate, sodium percarbonate, or sodium acetate.

7. The production method of an antimicrobial cellulosic fiber according to claim 1, wherein
the cellulosic fiber is a plant fiber, a regenerated fiber, a natural protein fiber or a regenerated protein fiber.

8. The production method of an antimicrobial cellulosic fiber according to claim 1, wherein
the antibacterial cellulosic fiber has a bacteriostasis rate ranged from 99% to 99.99%, and a deodorization rate of an alkaline odor ranged from 90% to 100%.

9. An antimicrobial cellulosic fiber or fabric, comprising a cellulosic fiber structural body, wherein the antimicrobial cellulosic fiber or fabric is produced by following method:
preparing a reactive antibacterial compound, the step of preparing the reactive antibacterial compound further comprises
preparing an aqueous dispersoid, wherein in the aqueous dispersoid, a concentration of the reactive compound is 10-300 g/l;
adding an antibacterial agent to the aqueous dispersoid so that the reactive compound and the antibacterial agent react at a temperature of 10° C.-90° C. for 0.5-6 hours to obtain a reactive antibacterial compound solution;
drying the reactive antibacterial compound solution and then crushing to obtain a purified reactive antibacterial compound;
preparing the antimicrobial cellulosic fiber, wherein the step of preparing the antimicrobial cellulosic fiber further comprises:
performing a chemical immobilization, wherein the chemical immobilization comprises:
immersing a cellulosic fiber or fabric in an aqueous solution comprising 10-100 g/l reactive antibacterial compound, 5-50 g/l sodium carbonate, 20-200 g/l sodium sulfate with a bath ratio of 1:5-50; and reacting at a temperature of 40° C.-90° C. for 10-100 mins to form a chemical bond; or
the chemical immobilization is implemented by performing a padding-drying process comprising: padding the cellulosic fiber or fabric in a solution comprising 10-100 g/l reactive antibacterial compound, 10-100 g/L sodium carbonate, and 10-100 g/L sodium sulfate, then processing a padded cellulosic fiber or fabric at a temperature of 100° C.-180° C. by a first steam or dry heat treatment; making a weight of the reactive antibacterial compound to be 0.1-10.0% of a weight of the cellulosic fiber through the chemical immobilization, and obtaining the cellulosic fiber structural body;
and processing the cellulosic fiber structural body by a metal promoter or a heat treatment to stabilize the cellulosic fiber structural body and obtain the antimicrobial cellulosic fiber.

10. The antimicrobial cellulosic fiber or fabric according to claim 9, wherein
the step of performing stabilization by using the metal promoter comprises:
heating the cellulosic fiber structural body and 0.5-5% metal promoter at a temperature of 10° C.-90° C. until a weight of the metal promoter reaches 0.05-5.00% of the weight of the cellulosic fiber;
the step of the heat treatment comprises: immersing the cellulosic fiber structural body in an aqueous solution of at least one item selected from the group consisting of organometallic compound, organosilicon compound, organofluorine compound, organophosphorus compound, and organonitrogen compound; and
performing a second steam or dry heat treatment at a temperature of 100° C.-200° C. for 10 seconds-10 minutes.

11. The antimicrobial cellulosic fiber or fabric according to claim 9, wherein
the reactive compound is one or more item selected from the group consisting of triazine compound, pyrimidine compound, quinoxaline compound, divinyl sulfone compound, epoxy compound, carbamate compound, and acrylamide compound.

12. The antimicrobial cellulosic fiber or fabric according to claim 11, wherein
the triazine compound is cyanuric chloride, the pyrimidine compound is tetrachloropyrimidine, the quinoxaline compound is chlorocarbonyl dichloroquinoxaline, the divinyl sulfone compound is sulfoethanesulfonic acid, the epoxy compound is epichlorohydrin, the carbamate compound is glyoxal carbamate, and the acrylamide compound is bromoacetamide.

13. The antimicrobial cellulosic fiber or fabric according to claim 9, wherein
the antibacterial agent is one or more item selected from the group consisting of natural antibacterial agent, synthetic antibacterial agent, antifungal agent, and antiviral agent;
wherein, the natural antibacterial agent is one or more item selected from the group consisting of macrolides, aminoglycosides, cephalosporins, penicillins, chitosans, chitins, hyaluronic acids, alginates, carrageenan, xanthan gum, gellan, amino acids, and proteins; and
the synthetic antibacterial agent is one or more item selected from the group consisting of carbostyril, sulfonamides, diamidines, bisphenols, guanidines, biguanides, imidazoliums, quanethidines, sulfanilic acid, salicylic acid, aminobenzoic acid, hydantoin, and imidazolinone.

14. The antimicrobial cellulosic fiber or fabric according to claim 9, wherein in the step of adding an antibacterial agent to the aqueous dispersoid, an alkali is further added as a catalyst to accelerate the reaction; and
the alkali is caustic soda, sodium carbonate, sodium percarbonate, or sodium acetate.

15. The antimicrobial cellulosic fiber or fabric according to claim 9, wherein the cellulosic fiber is a plant fiber, a regenerated fiber, a natural protein fiber or a regenerated protein fiber.

16. The antimicrobial cellulosic fiber or fabric according to claim 8, wherein the antibacterial cellulosic fiber has a bacteriostasis rate ranged from 99% to 99.99%, and a deodorization rate of an alkaline odor ranged from 90% to 100%.
